(19) United States
(12) Patent Application Publication
(10) Pub. No.: US 2022/0380993 A1
(43) Pub. Date: Dec. 1, 2022

(54) LIQUID CIRCULATOR

(71) Applicant: Kasco Marine, Inc., Prescott, WI (US)

(72) Inventor: Chad Attlesey, Prescott, WI (US)

(21) Appl. No.: 17/664,735

(22) Filed: May 24, 2022

Related U.S. Application Data
(60) Provisional application No. 63/192,743, filed on May 25, 2021.

(51) Int. Cl. E02B 1/00; F04D 33/00; F04D 13/08

(52) U.S. Cl. CPC E02B 1/003; F04D 33/00; F04D 13/086

(57) ABSTRACT

A circulator is described that is configured to circulate liquids such as water, chemical mixtures, suspensions and the like. The circulator has an oscillation shaft disposed within, for example concentrically disposed within, a support tube that is used to mount the circulator to a support structure. Locating the oscillation shaft within the support tube makes the circulator more compact, achieves better alignment of the oscillation shaft and the support tube, and makes the circulator stronger compared to a circulator where the oscillation shaft is not disposed within a support tube. In one embodiment, the circulator can be used to create a continuous flow of water in a body of water including around marinas, areas around docks, and waterfronts.

### FIELD

This technical disclosure relates to a device for circulating liquids such as water, chemical mixtures, or suspensions.

### BACKGROUND

It is known to use a water circulator to create water circulation in a body of water to improve water quality and remove debris and sediment buildup. The water circulator may be fixed in position or it may oscillate to expand the area impacted by the circulating water.

### SUMMARY

A circulator is described that is configured to circulate liquids such as water, chemical mixtures, suspensions and the like. In one embodiment, the circulator can be used to create a continuous flow of water in a body of water including around marinas, areas around docks, and waterfronts. In this embodiment, the continuous water circulation created by the circulator helps to eliminate stagnant areas, remove weeds and debris and increase oxygen transfer, as well as prevent freezing of the water within the vicinity of the circulator. In another embodiment, the circulator described herein can be used to create circulation in other bodies of liquid including, but not limited to, treatment tanks for water and/or chemicals for mixing the contents to keep solids and chemicals in suspension and evenly distributed. The circulator described herein may also be referred to as a water circulator or as a liquid circulator.

The circulator has an oscillation shaft disposed within, for example concentrically disposed within, a support tube that is used to mount the circulator to a support structure such as a dock. Locating the oscillation shaft within the support tube makes the circulator more compact, achieves better alignment of the oscillation shaft and the support tube, and makes the circulator stronger compared to a circulator where the oscillation shaft is not disposed within a support tube.

In one embodiment, a circulator can include a support tube and an oscillation shaft disposed within the support tube, where the oscillation shaft is rotatable relative to the support tube in clockwise and counterclockwise directions. A head unit is mounted to the support tube and includes a housing, and an oscillation motor disposed in the housing and having an output drive shaft in driving engagement with the oscillation shaft to drive the oscillation shaft in clockwise and counterclockwise directions. In addition, a circulation assembly is mounted to the oscillation shaft at a lower end thereof, where the circulation assembly includes a rotatable propeller, and a drive motor connected to the rotatable propeller to rotate the rotatable propeller.

In another embodiment, the circulator can be used to create liquid circulation in a body of liquid, for example in treatment tanks for water and/or chemicals for mixing the contents to keep solids and chemicals in suspension and evenly distributed. In this example application, the circulator may be referred to as a liquid circulator.

### DRAWINGS

FIG. 1 is a perspective view of a circulator described herein.

FIG. 2 is a side view of the circulator of FIG. 1.

FIG. 3 is a close-up view of the head unit mounted at the top of the circulator.

FIG. 4 depicts the head unit with the housing removed to depict interior components of the head unit.

FIG. 5 is a close-up view of the connection between the circulation assembly and the oscillation shaft.

FIG. 6 is an end view of the circulator.

FIG. 7 illustrates another embodiment of a circulator that uses a cycloidal drive mechanism.

FIG. 8 is an exploded view of the cycloidal drive mechanism.

### DETAILED DESCRIPTION

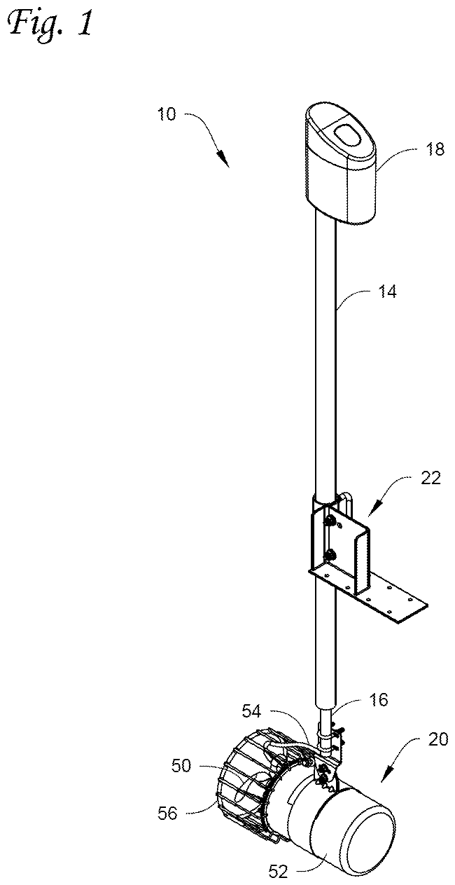

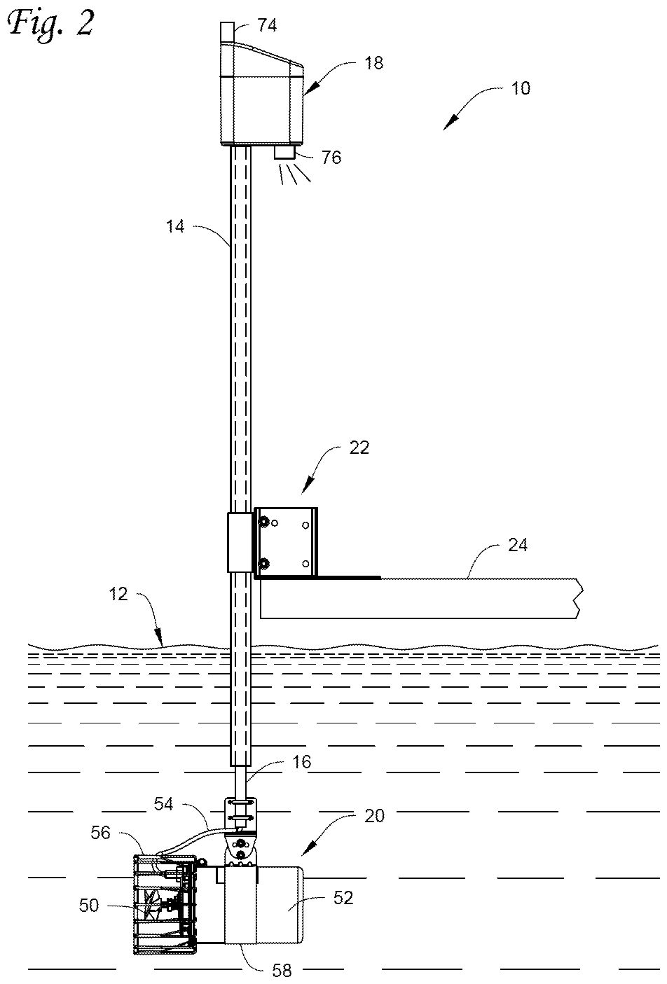

Referring to FIGS. 1-2, a circulator 10 (also referred to as a water circulator or as a liquid circulator) is illustrated. The circulator 10 is configured to create a continuous circulation within a body of liquid 12 (shown in FIG. 2). For example, the body of liquid 12 can be a lake, pond, river, canal and the like, and the circulator 10 of FIGS. 1-2 can be used to circulate water in a localized area in the body of water. The localized area may be at or near a marina, around or adjacent to a dock, near a waterfront or other location, and other locations in a body of water. However, the circulator 10 can be used to create circulation in other bodies of liquid other than water or mixtures of water and other liquid(s) including, but not limited to, treatment tanks for water and/or chemicals for mixing the contents to keep solids and chemicals in suspension and evenly distributed.

With continued reference to FIGS. 1-2, the circulator 10 includes a support tube 14, an oscillation shaft 16, a head unit 18, and a circulation assembly 20. In operation of the circulator 10, the circulator 10 is mounted by the support tube 14 such that the head unit 18 is disposed above and out of the liquid and the circulation assembly 20 is disposed within the liquid for creating a circulation of the liquid.

The support tube 14 has a tubular configuration and has an upper end located out of the liquid and connected to the head unit 18 and can have a lower end disposed in the liquid. The support tube 14 is stationary or fixed, i.e. the support tube 14 does not rotate during use. The support tube 14 may be circular in cross-section or have another cross-sectional shape such as square, rectangular or triangular as long as the oscillation shaft 16 can extend through the support tube 14. The support tube 14 can be formed of material that is suitable for use in a liquid environment such as metal or plastic. A mount bracket 22 (or a dock mount when used as a water circulator in a body of water) is connected to the support tube 14 for mounting the support tube 14, and thus mounting the entire circulator 10, to a support structure 24 (visible in FIG. 2) such as a dock or pier when used as a water circulator. A suitable mount bracket that can be used is available from Kasco Marine of Prescott, Wis.

The oscillation shaft 16 is disposed within and extends through the support tube 14. The oscillation shaft 16 is rotatable relative to the support tube 14 in clockwise and counterclockwise directions to cause oscillation of the circulation assembly 20 about the axis of the oscillation shaft 16 along a horizontal plane in clockwise and counterclockwise directions. The oscillation shaft 16 may be concentrically disposed within the support tube 14 so that the longitudinal axis of the oscillation shaft 16 matches the longitudinal axis of the support tube 14. The oscillation shaft 16 may be solid or tubular, and the oscillation shaft 16 may be circular in cross-section or have another cross-sectional shape such as square, rectangular or triangular as long as the oscillation shaft 16 can extend through the support tube 14 and rotate relative to the support tube 14. The oscillation shaft 16 can be formed of material that is suitable for use in a liquid environment such as metal or plastic. As described in more detail below, an upper end of the oscillation shaft 16 extends into the head unit 18 and is driven by an oscillation motor in the head unit 18. As seen in FIGS. 1 and 2, the lower end of the oscillation shaft 16 extends past the lower end of the support tube 14 and is attached to the circulation assembly 20.

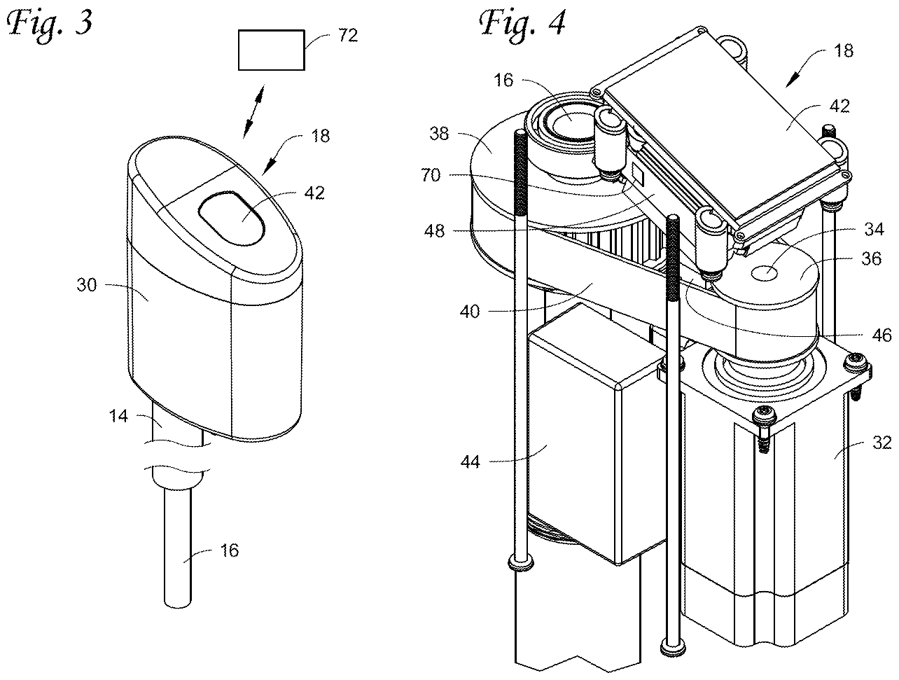

Referring to FIGS. 3-4, the head unit 18 is mounted to the upper end of the support tube 14. The head unit 18 is configured to control operation of the circulator 10 including causing oscillation of the circulation assembly 20 via the oscillation shaft 16. The head unit 18 includes a housing 30 and an electric oscillation motor 32 disposed in the housing 30. The electric oscillation motor 32 has an output drive shaft 34 that is in driving engagement with the oscillation shaft 16 via any suitable drive train to drive the oscillation shaft 16 in clockwise and counterclockwise directions. The electric oscillation motor 32 can be any type of reversible electric motor that is suitable for driving the oscillation shaft 16. For example, the motor 32 can be a stepper motor which provides more precise speed control and positional control of the oscillation.

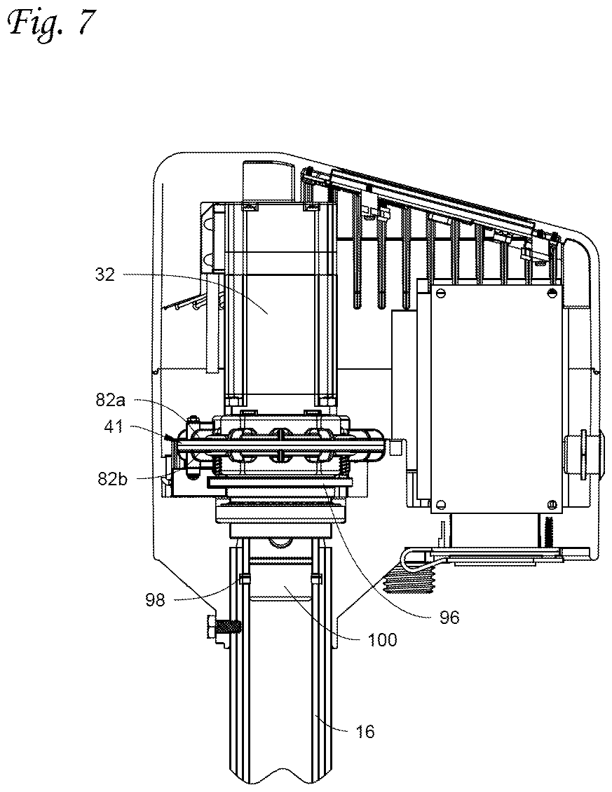

A drive train is provided between the output drive shaft 34 and the oscillation shaft 16. The drive train can have any configuration to impart oscillating rotation of the drive shaft 34 to the oscillation shaft 16. In the example illustrated in FIG. 4, the drive train includes a first drive pulley 36 connected to and driven by the output drive shaft 34, a second drive pulley 38 connected to and driving the oscillation shaft 16, and a drive belt 40 engaged with the first drive pulley 36 and the second drive pulley 38. The drive pulleys 36, 38 can have teeth that are engaged with teeth on the inner surface of the belt 40 to ensure non-slip driving between the belt 40 and the pulleys 36, 38. The rotation of the output shaft 34 drives the pulley 36 which in turn drives the pulley 38 via the belt 40 to cause rotation of the oscillation shaft 16 in the desired direction depending upon the rotation direction of the output shaft 34. However, other drive trains can be used including, but not limited to, gears and a chain. For example, FIG. 7 illustrates the drive train as being a cycloidal drive 41 between the drive shaft of the motor 32 and the oscillation shaft 16. The general construction and operation of cycloidal drive mechanisms is well-known in the art.

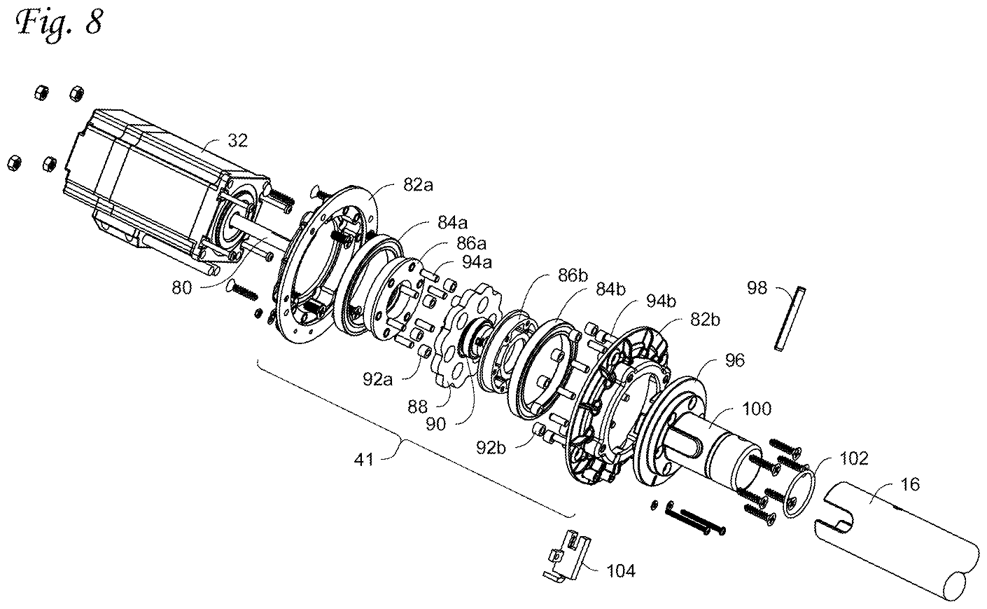

FIGS. 7 and 8 illustrate in detail the connection between the motor 32, the cycloidal drive 41 and the oscillation shaft 16. In particular, the connection is in-line where the drive shaft 80 of the motor 32 is in-line with and coaxial to the oscillation shaft 16. The cycloidal drive 41 includes upper and lower outer lids/post supports 82a, 82b, upper and lower bearings 84a, 84b, upper and lower inner caps/post supports 86a, 86b, cycloidal wheel 88, cam and bearing assembly 90, upper and lower sets of roller bushings 92a, 92b, and upper and lower post/roller bushings 94a, 94b. In addition, the connection includes an optical rotation/end-stop sensor disk 96, an oscillation shaft set pin 98, an oscillation shaft torque transfer tube 100, an oscillation shaft gasket 102, and a photo-interrupter sensor 104.

As seen in FIGS. 3-4, the head unit 18 further includes a touch-sensitive control screen 42 (i.e. a touchscreen) through which control inputs can be entered for controlling operation of the circulator 10. Examples of control inputs that can be input via the control screen 42 include, but are not limited to, on/off control of the circulator 10, on/off control of the motor of the circulation assembly 20, speed control of the motor of the circulation assembly 20, on/off control of the oscillation motor 32, speed control of the oscillation motor 32, and permit adjustment of the angular oscillation extent of the oscillation motor 32 thereby controlling the oscillation range (i.e. the amount of sweep) of the circulation assembly 20 when driven by the oscillation shaft 16. The head unit 18 further includes an AC-DC converter 44, an AC power relay 46, and control electronics 48. Electrical power for the circulator 10 can be provided via a power cord plugging into a conventional electrical outlet. Conventional circulators typically utilize two power cords, the first extending from an electrical outlet to the controller and the second extending from an electrical outlet to the circulation assembly. In another embodiment, the circulator 10 can be powered by one or more batteries and/or by one or more solar panels.

Operation of the circulator 10 may also be wirelessly controlled. For example, referring to FIGS. 3 and 4, the head unit 18 may include a wireless transceiver 70 that can receive wireless control signals from a control device 72, such as a mobile phone, tablet or other suitable device, for controlling the circulator 10. In an embodiment, the transceiver 70 may also wirelessly transmit one or more signals, such as operational data or operational status of the circulator 10, to the control device. Any type of wireless communication technology can be used including, but not limited to, WiFi, Bluetooth®, ZigBee, and others.

Referring to FIG. 2, the head unit 18 may include one or more lights. For example, the head unit 18 can include one or more lights 74 thereon that can be located at any position on the head unit 18 such that the light emitted therefrom is visible from the exterior of the head unit 18. The light 74 may continuously illuminate or the light 74 may be controlled to strobe (i.e. repeatedly flash on and off). When illuminated, the light 74 may act as a homing beacon to allow a user to locate the dock at night. In addition or alternatively, the head unit 18 can include one or more lights 76 thereon. The light 76 can be positioned at any position on the head unit 18 such that light emitted therefrom shines generally downward to illuminate the adjacent surface of the support structure 24, such as a dock thereby making walking on the dock safer at night, reduce tripping hazard, and the like. In one embodiment, a single light that performs the functions of the lights 74, 76 can be used.

The lights 74, 76 may include one or more light emitting diodes or other light emitting elements. The lights 74, 76 may emit white light or colored light such as red or blue, or the lights 74, 76 may alternate between white and colored light. Operation of the lights 74, 76 may be controlled via the control screen 42, remotely via the control device 72, the lights 74, 76 may be operated by a timer, or the head unit 18 can include a photosensor that detects ambient light levels and that activates the lights 74, 76 when it becomes dark outside.

Returning to FIGS. 1-2, the circulation assembly 20 is mounted to the oscillation shaft 16 at a lower end thereof so that the circulation assembly 20 oscillates with the oscillation shaft 16. The circulation assembly 20 is configured to generate the liquid circulation and includes a rotatable propeller 50 and a drive motor 52 connected to the rotatable propeller 50 to rotate the rotatable propeller 50. The propeller 50 can have any configuration that generates a flow of liquid when rotated. The flow of liquid generated by the propeller 50 can be an axial flow of liquid that flows in a direction away from the drive motor 52. The drive motor 52 can be a one-way, electrically driven motor. Electrical power for powering the drive motor 52 can be provided by an electrical power cord 54 that can be routed from the head unit 18 and through either the oscillation shaft 16 or through the support tube 14. In one embodiment, a propeller guard 56 can be provided around the propeller 50 to protect against contact with the propeller 50 and to prevent large debris from reaching the propeller 50.

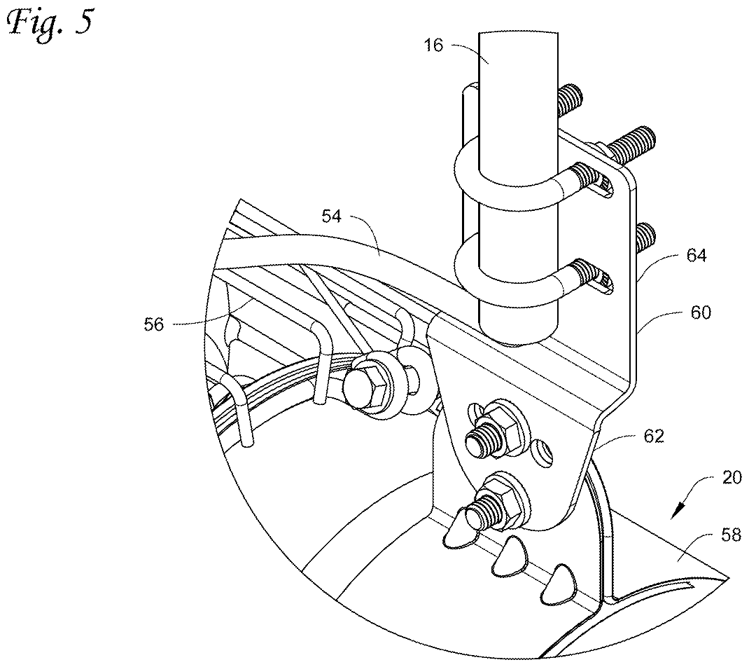

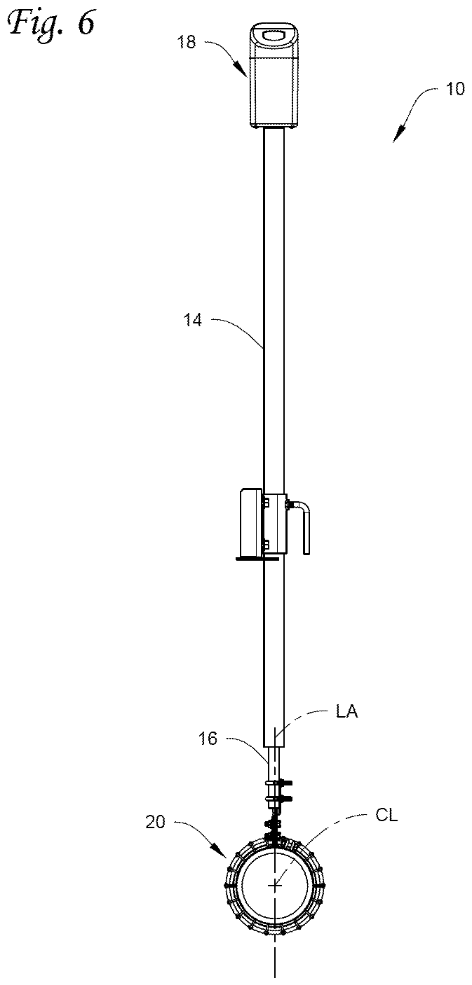

Referring to FIGS. 2 and 5-6, the circulation assembly 20 can be fixed to the oscillation shaft 16 in such a manner so that, in an end view of the circulator 10 (see FIG. 6), the axial centerline CL of the circulation assembly 20 is intersected by the longitudinal axis LA of the oscillation shaft 16. This avoids an off-axis load from the thrust of the circulation assembly 20 and reduces stress on the support tube 14, the oscillation shaft 16, and attachment points. Any type of mounting that achieves intersection between the longitudinal axis LA of the oscillation shaft 16 and the axial centerline CL of the circulation assembly 20 can be used. In the illustrated example, the mounting comprises a circular clamp 58 surrounding the drive motor 52, and a bracket 60 that attaches the clamp 58 to the oscillation shaft 16. The clamp 58 is located at approximately the midpoint of the drive motor 52. The bracket 60 includes a lower portion 62 and an upper portion 64 that is offset from the lower portion 62. The bottom portion of the oscillation shaft 16 is clamped to the offset upper portion 64. The offset of the upper portion 64 is sufficient to ensure that the longitudinal axis LA of the oscillation shaft 16 intersects the axial centerline CL of the circulation assembly 20. However, other mechanisms for attaching the circulation assembly 20 to the oscillation shaft 16 can be used.

In one embodiment, the circulation assembly 20 can be mounted to the oscillation shaft 16 in a manner to permit vertical angle adjustment of the circulation assembly 20. The adjustment of the vertical angle may be manual by adjusting the mounting between the oscillation shaft 16 and the circulation assembly 20 via different adjustment positions on the bracket 60. In another embodiment, the adjustment of the vertical angle may be automated, for example using a linkage between the head unit 18 and the circulation assembly 20 which is driven by a motor on the head unit 18. In another embodiment, the circulation assembly 20 can be continuously oscillated side-to-side as well as continuously driven to oscillate by changing its vertical angle up and down as it oscillates side-to-side. This complex side-to-side oscillation and up-down oscillation would affect the liquid flow over a larger range compared to a fixed vertical angle of the circulation assembly 20.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A circulator, comprising:
a support tube;
an oscillation shaft disposed within the support tube, the oscillation shaft is rotatable relative to the support tube in clockwise and counterclockwise directions;
a head unit mounted to the support tube, the head unit includes a housing, and an oscillation motor disposed in the housing and having an output drive shaft in driving engagement with the oscillation shaft to drive the oscillation shaft in clockwise and counterclockwise directions; and
a circulation assembly mounted to the oscillation shaft at a lower end thereof, the circulation assembly includes a rotatable propeller, and a drive motor connected to the rotatable propeller to rotate the rotatable propeller.

2. The circulator of claim 1, wherein the oscillation shaft is concentrically disposed within the support tube.

3. The circulator of claim 1, further comprising a dock mount connected to the support tube.

4. The circulator of claim 1, wherein the head unit includes a touch-sensitive control screen that controls operation of the oscillation motor.

5. The circulator of claim 1, wherein the oscillation motor comprises a stepper motor, and further comprising a drive train between the output drive shaft and the oscillation shaft.

6. The circulator of claim 5, wherein the drive train comprises a cycloidal drive.

7. The circulator of claim 1, wherein the output drive shaft is in-line with and coaxial to the oscillation shaft.

8. The circulator of claim 1, further comprising a homing beacon light mounted on the head unit.

9. The circulator of claim 1, further comprising a light mounted on the head unit, the light positioned to emit light in a downward direction toward a support structure.

10. The circulator of claim 1, wherein the head unit includes a wireless communication device.

11. A liquid circulator for creating liquid circulation in a body of liquid, comprising:
a support tube configured to be mounted to a support structure;
an oscillation shaft concentrically disposed within the support tube, the oscillation shaft is rotatable relative to the support tube in clockwise and counterclockwise directions;
a head unit mounted to the support tube and configured to reside above the liquid, the head unit includes a housing, and an electric oscillation motor disposed in the housing and having an output drive shaft in driving engagement with the oscillation shaft to drive the oscillation shaft in clockwise and counterclockwise directions; and
a liquid circulation assembly mounted to the oscillation shaft at a lower end thereof so as to be oscillated by the oscillation shaft and configured to reside in the liquid to create the liquid circulation, the liquid circulation assembly includes a rotatable liquid propeller, and an electric drive motor connected to the rotatable liquid propeller to rotate the rotatable liquid propeller.

12. The liquid circulator of claim 11, further comprising a mount bracket connected to the support tube to mount the support tube to the support structure.

13. The liquid circulator of claim 11, wherein the head unit includes a touch-sensitive control screen that controls operation of the electric oscillation motor.

14. The liquid circulator of claim 11, wherein the electric oscillation motor comprises a stepper motor, and further comprising a drive train between the output drive shaft and the oscillation shaft.

15. The liquid circulator of claim 14, wherein the drive train comprises a cycloidal drive.

16. The liquid circulator of claim 11, wherein the output drive shaft is in-line with and coaxial to the oscillation shaft.

17. The liquid circulator of claim 11, further comprising a homing beacon light mounted on the head unit.

18. The liquid circulator of claim 11, further comprising a light mounted on the head unit, the light positioned to emit light in a downward direction toward a support structure.

19. The liquid circulator of claim 11, wherein the head unit includes a wireless communication device.
